(19) United States
(12) Patent Application Publication
(10) Pub. No.: US 2016/0314800 A1
(43) Pub. Date: Oct. 27, 2016

(54) COMPUTATIONALLY EFFICIENT METHOD FOR FILTERING NOISE

(71) Applicant: ANALOG DEVICES, INC., Norwood, MA (US)

(72) Inventor: NOAH DANIEL STEIN, SOMERVILLE, MA (US)

(73) Assignee: ANALOG DEVICES, INC., Norwood, MA (US)

(21) Appl. No.: 15/102,623

(22) PCT Filed: Dec. 22, 2014
(86) PCT No.: PCT/US2014/071970

§ 371 Date: Jun. 8, 2016

Related U.S. Application Data
(60) Provisional application No. 61/919,851, filed on Dec. 23, 2013.

(51) Int. Cl. G10L 21/0208

(52) U.S. Cl. CPC G10L 21/0208

(57) ABSTRACT

Systems and methods for filtering noise from an input signal in a computationally efficient manner are provided. A method includes generating a raw noisy matrix representing the input signal, wherein each element of the raw noisy matrix represents a portion of the input signal, initializing a denoised matrix as equal to the raw noisy matrix, and updating the denoised matrix. Updating the denoised matrix includes iteratively convolving a current version of the denoised matrix with a kernel to generate a convolution matrix, and modifying the denoised matrix based in part on values in the convolution matrix.

### CROSS-REFERENCE TO RELATED APPLICATION

This application claims the benefit of and priority from U.S. Provisional Patent Application 61/919,851 filed 23 Dec. 2013 entitled “SMOOTHING TIME-FREQUENCY SOURCE SEPARATION MASKS”, which is incorporated herein by reference in its entirety.

### TECHNICAL FIELD OF THE DISCLOSURE

The present invention relates to the field of signal processing, and in particular to reducing noise.

### BACKGROUND

One approach to processing of a signal, such as an audio signal, to select or extract a signal of interest from the original signal is to decompose the original signal into components and then determine a mask having numerical or Boolean mask values such that each mask value corresponds to one of the components. The signal of interest is then determined by scaling or selecting the components of the original signal according to the mask values. In some examples, the components have compact time and frequency support (e.g., a 10 ms extent in time and a 10 Hz range in frequency), although other decomposition approaches than time versus frequency bins may be used.

One approach to source separation of a signal involves extraction of a signal of interest associated with a desired source, for example, in a particular direction from microphones that acquire the signal. An audio signal is acquired using multiple microphones, and direction-of-arrival (DOA) information computed as a function of time and frequency, for example, according to a set discrete time-frequency components. A number of techniques can be used to generate mask values at each of the time-frequency bins that represent whether a desired source is present. These mask values may be binary (e.g., zero or one) or continuous (e.g., a real number in the range zero to one). The mask values may then be used to select desired components of the input signal to form an output signal that represents a desired signal from the source of interest. Many techniques use relatively local processing of the input signal and therefore have local errors or biases, with a result that the output signal has undesirable characteristics, such as audio artifacts.

One way to address the errors and/or local processing that produces a mask is to perform a smoothing of the mask, for example, by two-dimensional filtering (e.g., convolution in time-frequency space). Another way is to view the input mask values as noisy observations of a binary Markov Random Field (MRF) for example as an independently generated observation yielding each input mask value. The MRF is characterized by conditional distributions of the mask value at one time-frequency location based on the mask values at neighboring locations, for example, according to the four or eight nearest neighbors in the time-frequency mask. In some examples, the conditional distribution is explicitly defined, while in some examples, a potential function induces the conditional distribution function. The hidden mask values that are inferred from the noisy input mask values form the output mask, which is used for extraction or selection of the desired signal. The output mask can be considered to be the hidden values of the MRF conditioned on the noisy observations (e.g., a Bayesian estimate of the output mask). Such a smoothed set of mask values may be obtained through a process of Gibbs sampling, in which an iteration is performed in which at each iteration, one time-frequency location is considered for update depending on its neighboring values and a random value drawn for that iteration. Concurrent updating of a large fraction of mask values is not generally possible while maintaining equivalence to the sequential update process of conventional Gibbs sampling.

### OVERVIEW

In one aspect, a method for filtering noise from an input signal in a computationally efficient manner is provided. The method comprises generating a raw noisy matrix representing the input signal, wherein each element of the raw noisy matrix represents a portion of the input signal, initializing a denoised matrix as equal to the raw noisy matrix, and updating the denoised matrix. The denoised matrix is updated by iteratively convolving a current version of the denoised matrix with a kernel to generate a convolution matrix, and modifying the denoised matrix based in part on values in the convolution matrix.

In some implementation, the method further comprises generating a confidence-weighted noisy matrix, based on a confidence level of elements of the raw noisy matrix. In further implementations, updating the denoised matrix further comprises adding the convolution matrix and the confidence-weighted noisy matrix to produce a probabilistic strength matrix. In some examples, updating further comprises generating a matrix of probabilities based on the probabilistic strength matrix by applying a nonlinearity function to elements of the probabilistic strength matrix to generate a matrix of probabilities, and the denoised matrix is modified based on a subset of elements in the matrix of probabilities. According to some examples, the nonlinearity function is a sigmoid function.

In various implementations, updating the denoised matrix further comprises selecting the subset of elements in the probabilistic strength matrix, and replacing values of corresponding elements in the denoised matrix with new values based on probabilities in corresponding elements in the matrix of probabilities.

In some implementations, the method further comprises generating a weighting matrix, wherein the weighting matrix is the same size as the raw noisy matrix, and wherein each element of the weighting matrix represents a confidence level of a corresponding element of the raw noisy matrix, and generating a confidence-weighted noisy matrix based on the raw noisy matrix and the weighting matrix. In some examples, combining comprises multiplying element-wise the weighting matrix by raw noisy matrix.

In some implementations, the method further comprises outputting the denoised matrix. In some examples, the method further comprises averaging a plurality of denoised matrices each generated at an updating iteration, and outputting the average of the plurality of denoised matrices.

In some examples, the input signal is an audio signal and the raw noisy matrix elements each have a value based on information at a selected analysis frame and frequency. The methods can further include processing the input signal using a fast Fourier transform, and wherein the convolution of the current version of the denoised matrix and the kernel is in the frequency domain.

In same implementations, the method includes generating a raw noisy matrix includes generating a plurality of raw noisy matrices in parallel, each of the plurality of raw noisy matrices representing a portion of the input signal, and generating a weighting matrix, producing a confidence-weighted noisy matrix, initializing a denoised matrix, and updating the denoised matrix includes generating a plurality of weighting matrices in parallel, producing a plurality of confidence-weighted noisy matrices in parallel, initializing a plurality of denoised matrices in parallel, and updating the plurality of denoised matrices in parallel, each of the plurality of denoised matrices corresponding to one of the plurality of raw noisy matrices.

According to some implementations, the matrices described above can be one-dimensional matrices, including only one column and/or one row. The methods can be performed using arrays, including multi-dimensional arrays.

According to another aspect, a system for filtering noise from an input signal in a computationally efficient manner is provided. The system includes a receiver for receiving the input signal, and a computer-implemented processing module configured to generate a raw noisy matrix representing the input signal, wherein each element of the raw noisy matrix represents a portion of the input signal, initialize a denoised matrix as equal to the raw noisy matrix, and update the denoised matrix. Updating includes iteratively convolving a current version of the denoised matrix with a kernel to generate a convolution matrix, and modifying the denoised matrix based in part on values in the convolution matrix.

In some implementations, the computer-implemented processing module comprises a plurality of parallel computer-implemented processing modules, each configured to generate a parallel raw noisy matrix, wherein each of the plurality of parallel raw noisy matrices represents a portion of the input signal, and initialize and update a parallel denoised matrix, wherein each of the plurality of parallel denoised matrices corresponds to one of the plurality of parallel raw noisy matrices. In further implementations, each of the plurality of parallel computer-implemented processing modules updates a single element of a respective parallel denoised matrix.

In other implementations, the computer-implemented processing module comprises a plurality of parallel computer-implemented processing modules, each configured to select, in parallel, an element of the denoised matrix, and update, in parallel, the respective element of the denoised matrix. Each of the parallel computer-implemented processing modules selects a different element.

In another aspect, a method for filtering noise from an input signal in a computationally efficient manner is provided. The method is somewhat related to Gibbs Sampling, and may be performed on multiple update locations in parallel, sequentially, or in a mixed parallel and sequential mode. According to various implementations, the updating method can be used on audio input signals, video input signals, or other input signals. According to one example, the method is effective in smoothing time-frequency masks for source separation.

In some examples, the MRF is homogeneous, and the parallel updating uses a location-invariant convolution according to a fixed kernel to compute values at all locations. Then a subset of values at the locations is updated in a conventional Gibbs update (i.e., drawing a random value from a distribution computed by the parallel updates). In some examples, the convolution is implemented in a transform domain (e.g., Fourier Transform domain).

In another aspect, in general, a sampling approach is used to smooth a time-frequency mask using a Markov Random Field by updating a randomly selected fraction of time-frequency values at each iteration.

In another aspect, in general, an approach to random sampling of a Markov Random Field involves computing a convolution of a current set of time-frequency values with a kernel, and for each of a selected fraction of time-frequency values, updating those values according to a combination of the result of the convolution at that value and random values drawn for those values. In some examples, the convolution is computed in a transform domain, for example, a Fourier Transform domain. In some examples, the fraction of time-frequency values is selected at random.

In some examples, the approaches identified above are used for the purpose of smoothing an input time-frequency mask determined according to direction-of-arrival information, with the smoothed mask then being used to select a signal corresponding to a source at a particular direction.

An advantage of one or more aspects is an improved selection of a desired signal by efficient combination of relatively noisy input mask values to form an output mask that provides selected signal that is suitable for human or machine processing. The improvement may be manifested by improved perceptual and/or information retaining characteristics of the selected signal and/or by reduced computation requirements to perform the selection. The smoothing process may be implemented efficiently thereby making it appropriate for certain limited resource implementations (e.g., in circuitry implementing limited computation capacity).

Other features and advantages of the invention are apparent from the following description, and from the claims.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a flowchart illustrating a method for filtering noise from an input signal in a computationally efficient manner, according to some embodiments of the disclosure;

FIG. 2 is a flowchart illustrating a more detailed method for filtering noise from an input signal in a computationally efficient manner, according to some embodiments of the disclosure;

FIG. 3 is flowchart illustrating a method for filtering noise from an audio input signal in a computationally efficient manner, according to some embodiments of the disclosure;

FIG. 4 is a diagram illustrating a matrix of elements including neighbors, according to some embodiments of the disclosure;

FIG. 5A is a schematic illustrating an image with salt and pepper noise;

FIG. 5B is a schematic illustrating the image of FIG. 5A with noise filtered in a computationally efficient manner, according to some embodiments of the disclosure; and

FIG. 6 is a diagram illustrating a system for filtering noise from an input signal in a computationally efficient manner, according to some embodiments of the disclosure.

### DESCRIPTION OF EXAMPLE EMBODIMENTS OF THE DISCLOSURE

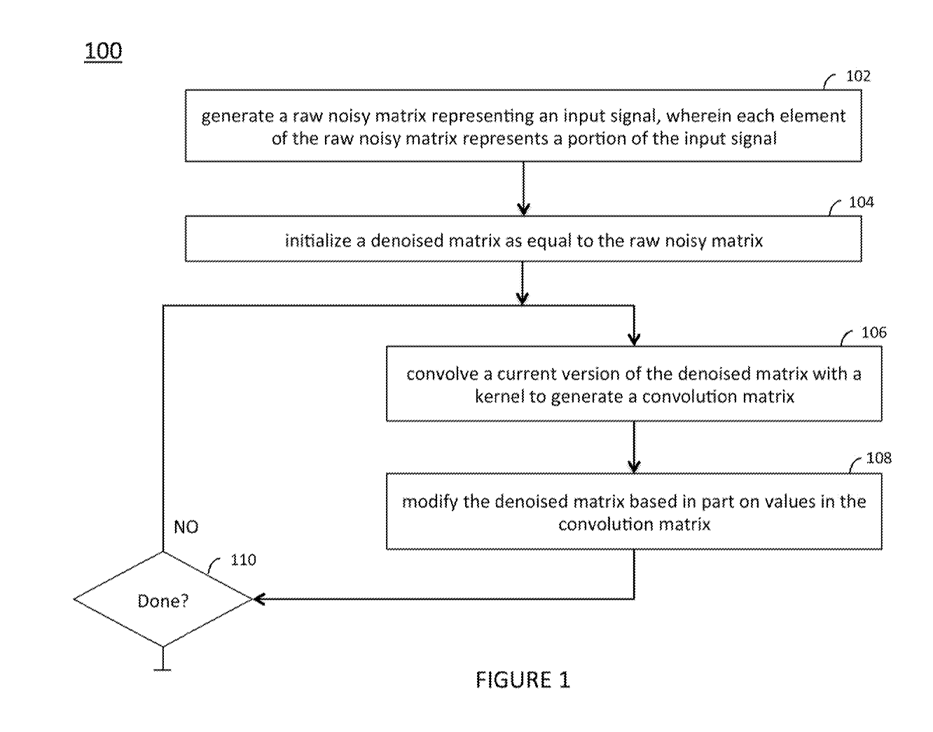

Systems and methods are provided for filtering noise from an input signal in a computationally efficient manner. FIG. 1 is a flowchart illustrating a method 100 for filtering noise from an input signal in a computationally efficient manner, according to some embodiments of the disclosure. The input signal may be an audio signal, a video signal, a one-dimensional signal, an RF signal, a radar signal, or any other type of signal. In one example, a one-dimensional input signal may be an indication of whether a source is on or off. The source may be a target signal, such as speech, or it may be a noise signal such as wind noise, engine noise, keyboard typing, or other background noise. In some implementations, the method 100 begins with receiving or acquiring the input signal. For example, an audio signal may be received at a microphone, and a video signal may be received at a camera.

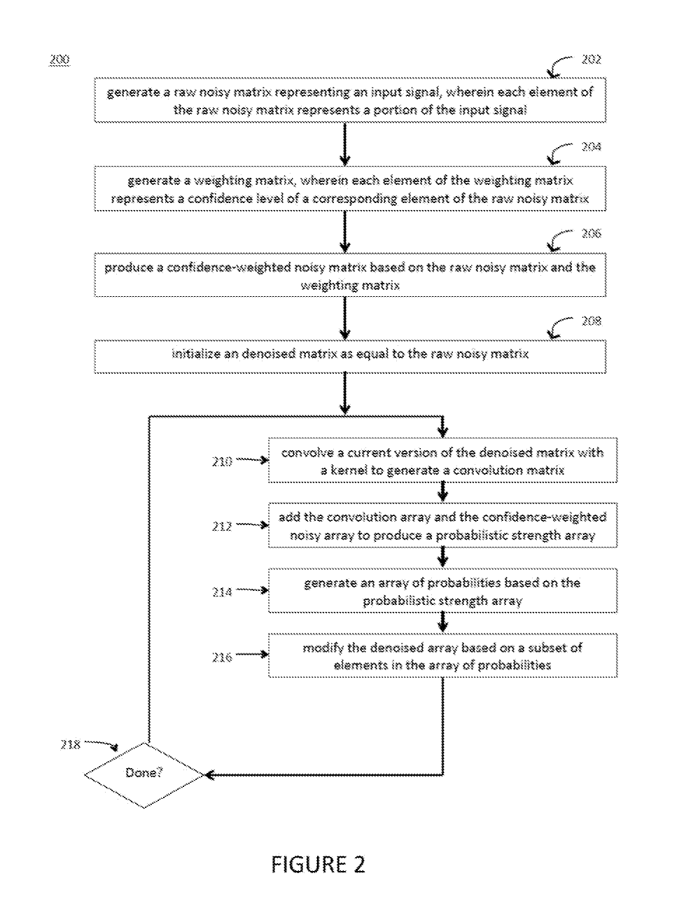

At step 102 of the method 100, a raw noisy matrix is generated. The raw noisy matrix represents an input signal, and each element of the raw noisy matrix represents a portion of the input signal. At step 104, a denoised matrix is initialized as equal to the raw noisy matrix. Next, the denoised matrix is updated via an iterative process beginning with step 106. At step 106, a current version of the denoised matrix is convolved with a kernel to generate a convolution matrix. At step 108, the denoised matrix is modified based in part on values in the convolution matrix. As described in greater detail below with respect to FIG. 2, the convolution matrix may be further processed to generate the values used to modify the denoised matrix. After step 108, at step 110, it is determined whether the iterative loop is finished and the update of the denoised matrix is complete, or whether to repeat steps 106 and 108, further updating the denoised matrix. In some examples, the iterative loop repeats a predetermined number of times (e.g., about 25 times, about 50 times, about 100 times, or more than 100 times).

Once the method 100 is complete, the modifications to denoised matrix have ended, and the final denoised matrix can be output. In other implementations, multiple versions of the denoised matrix as output from each of multiple iterations of step 108 are averaged to generate an averaged denoised matrix, and the averaged denoised matrix can be output.

According to some implementations, the matrices in the method 100 include only one row or one column. Thus, in some implementations, the matrices are arrays. In some implementations, the matrices are multidimensional arrays. In further implementations, the matrices include only one element.

According to some advantages, the method 100 provides a much more efficient and faster procedure for effectively filtering noise from a signal than traditional noise filtering methods such as conventional Gibbs sampling.

FIG. 2 is a flowchart illustrating a more detailed method for filtering noise from an input signal in a computationally efficient manner, according to some embodiments of the disclosure. As shown in FIG. 2, the method 200 begins at step 202 by generating a raw noisy matrix representing an input signal. In one example, a processing module, such as a processor, generates the matrix. Each element of the raw noisy matrix represents a portion of the input signal. In some examples, each element represents a time frame from the input signal at a specific frequency or a frequency range. Thus, for example, a specific time frame may be represented by multiple elements each representing one of multiple frequencies (or frequency ranges). In one example, the value of each element indicates whether the respective frequency at the respective time frame is on or off. In some examples, since the input signal is noisy, the value will indicate the whether the time-frequency location is likely to be on or off. For example, +1.0 may indicate “probably on” while −1.0 may indicate “probably off”. In some implementations, the values are binary, while in other implementations, the values are continuous.

According to some implementations, the value of each element of the raw noisy matrix is determined based on relative phase information. In other implementations, the value of each element is determined based on direction of arrival information. In further implementations, the value is determined based on magnitude. According to various embodiments, the value may be determined based on any received information. In some applications, instead of a raw noisy matrix, the system may generate a raw noisy matrix. In further applications, the system generates a plurality of parallel matrices, which are processed in parallel to filter the noise.

Once the raw noisy matrix has been generated, at step 204 a weighting matrix is generated. The weighting matrix is the same size as the raw noisy matrix, and each element of the weighting matrix represents a confidence level of a corresponding element of the raw noisy matrix. In one example, in audio applications, the confidence level regarding whether a time-frequency bin should be included in a mask is determined using a function of the energy in the time-frequency bin. For instance, weaker bins are more likely to give erroneous direction of arrival (DOA) information. The erroneous information can then be corrected using methods and systems described herein, in accordance with the present disclosure.

The confidence levels for elements of the weighting matrix may be determined based on a nearest-neighbor analysis. In particular, for a selected matrix location, values of neighboring locations may be considered in determining the confidence level of selected location. In general, if all of the nearest-neighbors have similar values, the value of the selected location is more likely to be correct (and receives a higher confidence level value) than if many, most, or all of the nearest-neighbors have different values from the value at the selected location.

At step 206, a confidence-weighted noisy matrix is produced using the raw noisy matrix and the weighting matrix. In one example, the raw noisy matrix is multiplied by the weighting matrix to produce the confidence-weighted noisy matrix.

At step 208, a denoised matrix is initialized as equal to the raw noisy matrix. The denoised matrix is then updated via multiple iterations of steps 210, 212, 214, and 216. In some implementations, the updated denoised matrix is returned as the output of the method 200 after the step 216. In other implementations, multiple versions of the denoised matrix as output from multiple iterations of step 216 are averaged to produce an averaged denoised matrix for output.

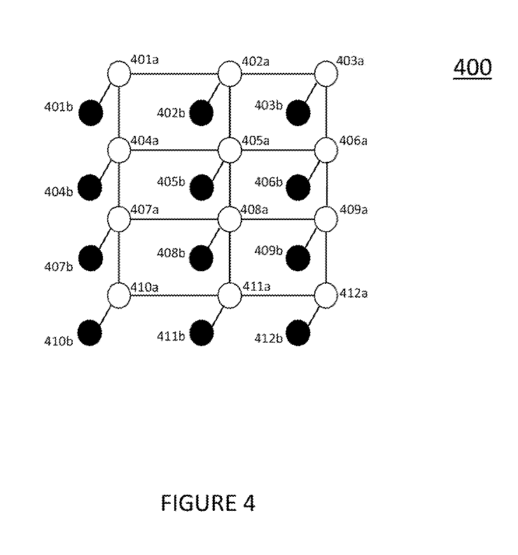

Updating the denoised matrix begins at step 220, in which a current version of the denoised matrix is convoled with a kernel to generate a convolution matrix. In some examples, the kernel is predetermined. In various implementations, the kernel can be any low-pass filter. In many implementations, the center value kernel (0,0)=0. The bandwidth of the kernel determines how smooth the output is. In some examples, the positions of nonzero values in the kernel are determined by signal processing considerations regarding which noisy bins are likely to be related to which noisy bins. For example, different STFT parameters induce different tradeoffs in time resolution, frequency resolution, and smearing. In some examples, the kernel values are determined to relate a first bin to one or more other selected bins, where the energy from the first bin is likely to have been smeared to the one or more other selected bins, and/or the energy from the one or more other selected bins is likely to have smeared to the first bin. In some implementations, the design of the kernel can involve an empirical process of determining what generates good performance. In some implementations, the kernel the pattern of nonzero elements in the kernel mirrors the neighborhood structure shown, for example, in FIG. 4, and discussed in greater detail below

At step 212, the convolution matrix is added to the confidence-weighted noisy matrix to produce a probabilistic strength matrix. In some examples, the elements of the probabilistic strength matrix are values indicating probabilistic strength. In other examples, the elements of the probabilistic strength matrix are logits.

At step 214, an matrix of probabilities is generated based on the probabilistic strength matrix. In some implementations, a sigmoid function is applied to the values in the probabilistic strength matrix to generate the matrix of probabilities. In other implementations, another nonlinearity function is applied to the values in the probabilistic strength matrix to generate the matrix of probabilities.

At step 216, the denoised matrix is modified based on a subset of elements in the matrix of probabilities. In some implementations, a subset of the locations in the denoised matrix is selected and the values in those locations in the denoised matrix are replaced with values of independent samples chosen according to the probabilities in the corresponding locations of the matrix of probabilities. In some examples, the subset of locations is randomly selected. In other examples, the subset of locations is selected based on a deterministic pattern.

At step 218, it is determined whether the iterative steps 210, 212, 214, and 216 are complete and the method 200 is done. If the method is not done, it returns to step 210 to begin another loop of iterations.

As described above with respect to the method 100 of FIG. 1, once the method 200 is complete, the modifications to denoised matrix have ended, and the final denoised matrix can be output. In other implementations, multiple versions of the denoised matrix as output from each of multiple iterations of step 216 are averaged to generate an averaged denoised matrix, and the averaged denoised matrix can be output.

According to some implementations, the methods 100 and 200 of FIGS. 1 and 2 can be used to filter noise form an audio signal. One approach to source separation of a signal, such as an audio signal acquired using multiple microphones, is to use direction-of-arrival (DOA) information computed as a function of time and frequency, for example, according to a set of discrete time-frequency bins. A number of techniques can be used to generate input mask values at each of the time-frequency bins that represent whether a desired source is present, for example, using a binary (e.g., zero or one) or continuous (e.g., a real number in the range zero to one). Examples of such techniques include those described in one or more of the following, each of which is incorporated herein by reference:
U.S. application Ser. No. 14/494,838, filed on Sep. 24, 2014, titled “TIME-FREQUENCY FACTORIZATION FOR DIRECTIONAL SOURCE SEPARATION,”
U.S. application Ser. No. 14/138,587, filed on Dec. 23, 2013, titled “SIGNAL SOURCE SEPARATION,”
International Application No. PCT/US2013/060044, filed on Sep. 17, 2013, titled “SOURCE SEPARATION USING A CIRCULAR MODEL.

The input mask values over a set of time-frequency locations that are determined by one or more of the approaches described above may have local errors or biases. Such errors or biases have the potential result that the output signal constructed from the masked signal has undesirable characteristics, such as audio artifacts.

Also as discussed above, one general class of approaches to “smoothing” or otherwise processing the mask values makes use of a binary Markov Random Field treating the input mask values effectively as “noisy” observations of the true but not known (i.e., the actually desired) output mask values. A number of techniques described below address the case of binary masks, however it should be understood that the techniques are directly applicable, or may be adapted, to the case of non-binary (e.g., continuous or multi-valued) masks. For example, underlying Markov Random Field may be binary, with the mask values representing probabilities or other measures of certainty of the corresponding field value being one versus zero. In yet other examples, the Markov Random Field itself is defined with values that can take more on more than two values (e.g., from a discrete or continuous set). In many situations, sequential updating using the Gibbs algorithm or related approaches may be computationally prohibitive. Available parallel updating procedures may not be available because the neighborhood structure of the Markov Random Field does not permit partitioning of the locations in such a way as to enable current parallel update procedures. For example, a model that conditions each value on the eight neighbors in the time-frequency grid is not amenable to a partition into subsets of locations of exact parallel updating.

Another approach is disclosed herein in which parallel updating for a Gibbs-like algorithm is based on selection of subsets of multiple update locations, recognizing that the conditional independence assumption may be violated for many locations being updated in parallel. Although this may mean that the distribution that is sampled is not precisely the one corresponding to the MRF, in practice this approach provides useful results.

A procedure presented herein therefore repeats in a sequence of update cycles. In each update cycle, a subset of locations (i.e., time-frequency components of the mask) is selected at random (e.g., selecting a random fraction, such as one half), according to a deterministic pattern, or in some examples forming the entire set of the locations.

According to one implementation, when updating in parallel in the situation in which the underlying MRF is homogeneous, location-invariant convolution according to a fixed kernel is used to compute values at all locations, and then the subset of values at the locations being updated are used in a conventional Gibbs update (e.g., drawing a random value and in at least some examples comparing at each update location). In some examples, the convolution is implemented in a transform domain (e.g., Fourier Transform domain). Use of the transform domain and/or the fixed convolution approach is also applicable in the exact situation where a suitable pattern (e.g., checkerboard pattern) of updates is chosen, for example, because the computational regularity provides a benefit that outweighs the computation of values that are ultimately not used.

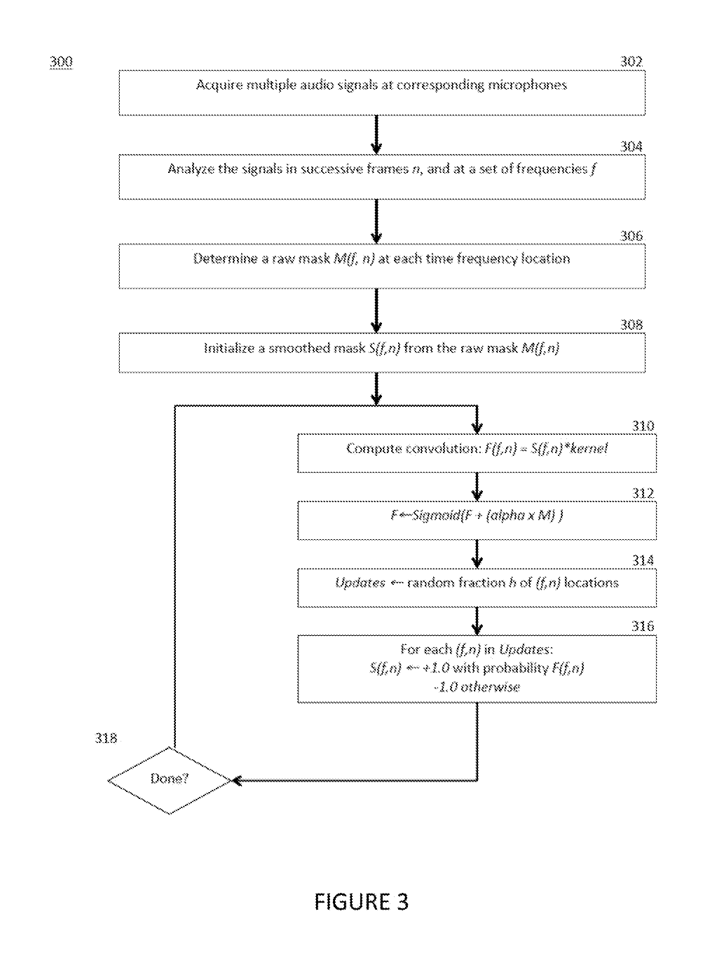

FIG. 3 is flowchart illustrating a method for filtering noise from an audio input signal in a computationally efficient manner, according to some embodiments of the disclosure. Note that the specific order of steps may be altered in some implementations, and steps may be implemented using different mathematical formulations without altering the essential aspects of the approach. First, at step 302, multiple audio signals are acquired at multiple sensors (e.g., microphones). At step 304, frames of the signals are analyzed at various frequencies. In at least some implementations, relative phase information at successive analysis frames (n) and frequencies (f) is determined. Based on this analysis, at step 306, a raw mask M(f,n) is determined at each time-frequency location. In one example, a value between −1.0 (i.e., a numerical quantity representing “probably off”) and +1.0 (i.e., a numerical quantity representing “probably on”) is determined for each time-frequency location as the raw (or input) mask M(f,n). In other applications, the input mask is determined in ways other than according to phase or direction of arrival information. An output of the method 300 is a smoothed mask S(f,n) The smoothed mask S(f,n) is initialized to be equal to the raw mask (step 308). A sequence of iterations of further steps is performed to update the smoothed mask S(f,n). In some examples, the sequence terminate after a predetermined number of iterations (e.g., 50 iterations). Each iteration begins at step 310 with a convolution of the current smoothed mask with a local kernel to form a filtered mask. In some examples, this kernel extends plus and minus one sample in time and frequency, with weights:

$$[ \begin{matrix}0.25 & 0.5 & 0.25 \\ 1.0 & 0.0 & 1.0 \\ 0.25 & 0.5 & 0.25\end{matrix} ]$$

At step 312, an updated filtered mask F(f,n), with values in the range 0.0 to 1.0 is formed. The updated filtered mask F is formed multiplying the original raw mask by a constant alpha, adding the product to the current value of the filtered mask, and passing the through a sigmoid 1/(1+exp(−x)). In one example, alpha=2.0. At step 314, a fraction h of the (f,n) locations, for example h=0.5, is selected at random or alternatively according to a deterministic pattern. In some examples, all of the locations are selected. A new sample for each selected location (each time-frequency bin) is set independently. Iteratively or in parallel, the smoothed mask S at these random locations is updated probabilistically at step 316, such that a location (f,n) selected to be updated is set to +1.0 with a probability F(f,n) and −1.0 with a probability (1−F(f,n)).

At the end of each iteration of steps 310-316, at step 318, it is determined whether to continue with another integration of steps 310, 312, 314 and 316, or whether to end the method 300. In one example, the method 300 repeats for a predetermined number of iterations.

According to some implementations, a further computation (not illustrated in the flowchart of FIG. 3) is optionally performed to determine a smoothed filtered mask SF(f,n). This mask is computed as the sigmoid function applied to the average of the filtered mask computed over a trailing range of the iterations, for example, with the average computed over the last 40 of 50 iterations, to yield a mask with quantities in the range 0.0 to 1.0.

FIG. 4 is a diagram illustrating a matrix 400 of elements including neighbors, according to some embodiments of the disclosure. In the matrix 400 includes four rows and three columns of elements 401a-412a. Furthermore, the matrix 400 includes a third-dimension, with an element 401b-412b corresponding to each element 401a-412a.

The matrix 400 illustrates elements and neighbors, wherein the values of neighbors can be used in the convolution step of the methods described above. In particular, an element such as a first element 405a has a first neighbor 402a to the north, second neighbor 406a to the east, third neighbor 408a to the south and fourth neighbor 404a to the west. In one example, the values of each of these neighbors 402a, 406a, 408a, and 404a is taken into consideration when generating the convolution of the value of the first element 405a.

The third dimension elements 401b-412b represents the observed values of the original raw noisy matrix. As the method 100 (or method 200) iterates, and the values of the denoised matrix are updated, the elements 401a-412a are still linked to the original observed values in elements 401b-412b, which continue to be considered to ensure that the values of the elements in the matrix 400 do not stray far from the original signal. Thus, each element 401a-412a in the matrix 400 considers both its nearest neighbors and its original observed value in the corresponding element 401b-412b.

In one example, a graph with north, south, east, west connections like FIG. 4 corresponds to a kernel such as:

$$\begin{matrix}θ & {x}_{n} & θ \\ {x}_{w} & θ & {x}_{e} \\ θ & {x}_{s} & θ\end{matrix}$$

where xₙ, x_{w}, xₑ, and xₛ denote nonzero values. A graph which also has northeast, southeast, northwest, and southwest connections would have a kernel such as:

$$\begin{matrix}{x}_{nw} & {x}_{n} & {x}_{ne} \\ {x}_{w} & θ & {x}_{e} \\ {x}_{sw} & {x}_{s} & {x}_{se}\end{matrix}$$

The neighborhood structure of the matrix 400 is invoked implicitly whenever the kernel is used. A matrix with longer range connections would use a larger kernel and consider elements further from the center element.

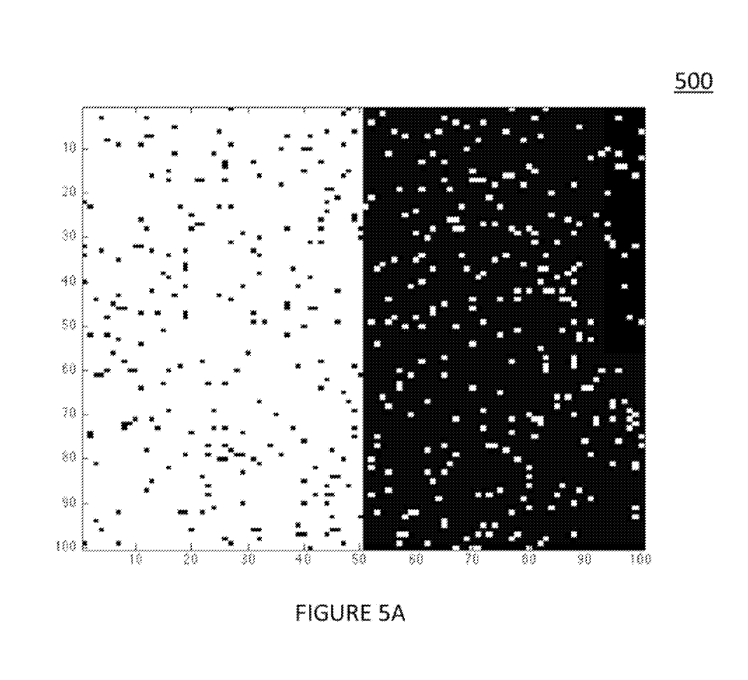

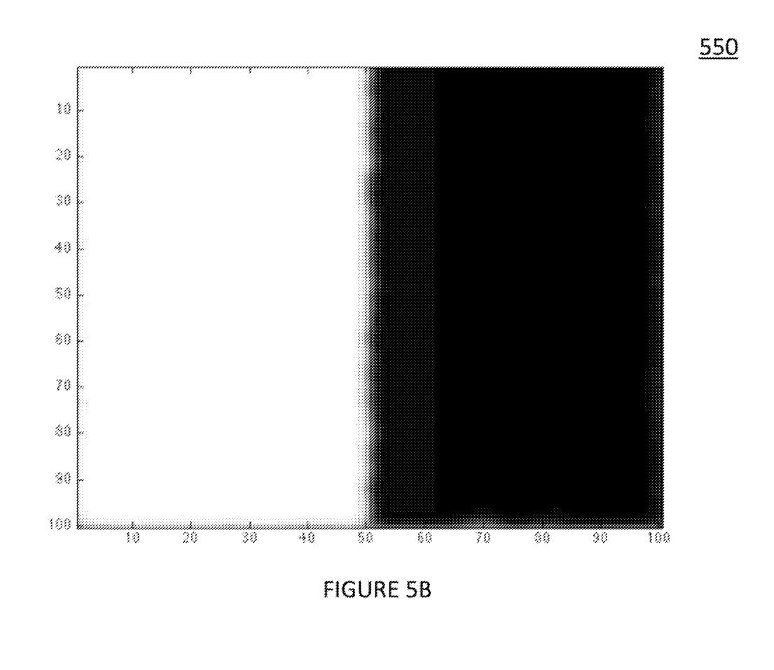

FIG. 5A is a schematic illustrating an image 500 with salt and pepper noise. As shown in the image 500, salt and pepper noise is generally single pixel noise. According to one example, after the image 500 is processed with the methods and systems disclosed herein, the image 550 of FIG. 5B is generated. FIG. 5B is a schematic illustrating the image of FIG. 5A with the salt and pepper noise filtered out, according to some embodiments of the disclosure. In various examples, the image 500 may be processed according to the method 100 of FIG. 1 to generate the image 500, or according to the method 200 of FIG. 2 to generate the image 500.

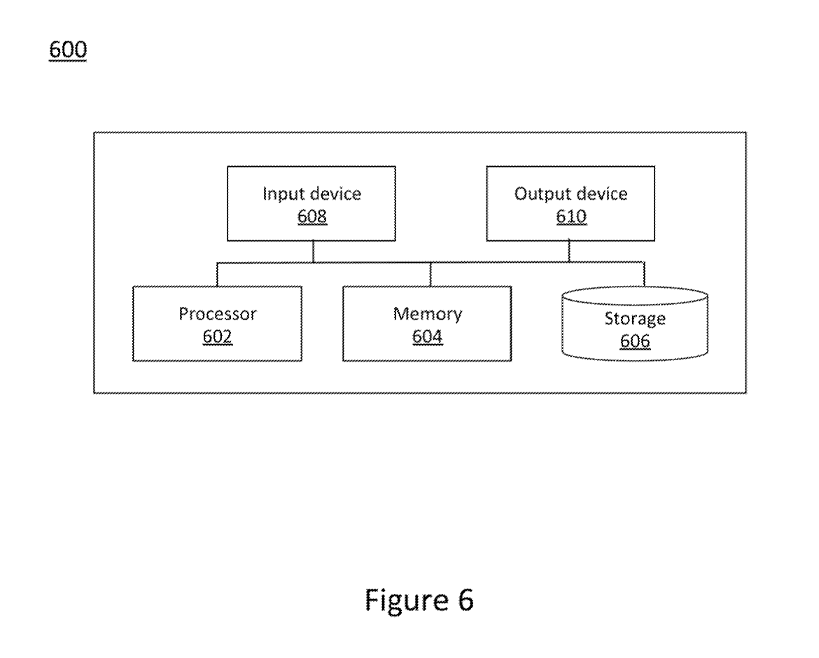

FIG. 6 is a diagram illustrating a system 500 for filtering noise from an input signal in a computationally efficient manner. The system 600 includes a processor 602, a memory 604, local storage 606, an input device 608 and an output device 610. In some examples, the input device 608 is one or more microphones for receiving audio signals. The processor 602 can perform the methods discussed herein, and may use one or both of the memory 604 and the local storage 606 to store matrices during processing. The system 600 may include one or more buffers. In some implementations, the system 600 includes more than one processor 602 for executing the computations involved in the methods disclosed herein, and the processors can execute the methods in parallel, improving efficiency. The output device 610 can be a speaker, a video screen, or any other output device used to transfer or communicate data out of the system 600. In some implementations, the system 600 is connected to a network and it may be connected to a cloud for cloud storage and other cloud services.

It should be understood that the approach described above for smoothing an input mask to form an output mask is applicable to a much wider range of applications than selection of time and component (e.g., frequency) indexed components of an audio signal. For example, the same approach may be used to smoothing a spatial mask for image processing, and may be used outside the domain of signal processing. Another areas in which the methods can be applied include medical/health care related applications including both imaging and acoustic applications such as echocardiograms, electrocardiograms, heartbeat detection and recordings, ultrasound, and MRI. A further application in which the methods can be applied is automotive technologies such as filtering out engine and wind noise, and imaging of the surroundings of the car. Some examples of technologies to which the methods can be applies include radar, lidar, and computer vision.

Implementations of the approaches described above may be integrated into a signal processing device, for example, for coupling to or incorporation within a multiple-microphone device (e.g., as described in Provisional Application No. 61/788,521, titled “Signal Source Separation”, which is incorporated herein by reference). The methods may be implemented in software, for example, having instructions stored on a tangible non-transitory computer readable medium (e.g., computer disk or semiconductor memory) for causing a processor (e.g., a general purpose microprocessor, a signal processor, etc.) to perform the steps described above. In some examples, some of the steps may be performed using hardware, for example, with an application specific integrated circuit.

### Variations and Implementations

In the discussions of the embodiments above, any components can readily be replaced, substituted, or otherwise modified in order to accommodate particular circuitry needs. Moreover, it should be noted that the use of complementary electronic devices, hardware, software, etc. offer an equally viable option for implementing the teachings of the present disclosure.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc, can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In another example embodiment, the electrical circuits of the FIGURES may be implemented as stand-alone modules (e.g., a device with associated components and circuitry configured to perform a specific application or function) or implemented as plug-in modules into application specific hardware of electronic devices. Note that particular embodiments of the present disclosure may be readily included in a system on chip (SOC) package, either in part, or in whole. An SOC represents an IC that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the computation functionalities may be implemented in one or more silicon cores in Application Specific Integrated Circuits (ASICs), Field Programmable Gate Arrays (FPGAs), and other semiconductor chips.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than in a restrictive sense.

Note that the activities discussed above with reference to the FIGURES are applicable to any integrated circuits that involve signal processing, particularly those that can execute specialized software programs, or algorithms, some of which may be associated with processing digitized real-time data. Certain embodiments can relate to multi-DSP signal processing, floating point processing, signal/control processing, fixed-function processing, microcontroller applications, etc.

In certain contexts, the features discussed herein can be applicable to medical systems, scientific instrumentation, wireless and wired communications, radar, industrial process control, audio and video equipment, current sensing, instrumentation (which can be highly precise), and other digital-processing-based systems.

Moreover, certain embodiments discussed above can be provisioned in digital signal processing technologies for medical imaging, patient monitoring, medical instrumentation, and home healthcare. This could include pulmonary monitors, accelerometers, heart rate monitors, pacemakers, etc. Other applications can involve automotive technologies for safety systems (e.g., stability control systems, driver assistance systems, braking systems, infotainment and interior applications of any kind). Furthermore, powertrain systems (for example, in hybrid and electric vehicles) can use high-precision data conversion products in battery monitoring, control systems, reporting controls, maintenance activities, etc.

In yet other example scenarios, the teachings of the present disclosure can be applicable in the industrial markets that include process control systems that help drive productivity, energy efficiency, and reliability. In consumer applications, the teachings of the signal processing circuits discussed above can be used for image processing, auto focus, and image stabilization (e.g., for digital still cameras, camcorders, etc.). Other consumer applications can include audio and video processors for home theater systems, DVD recorders, and high-definition televisions. Yet other consumer applications can involve advanced touch screen controllers (e.g., for any type of portable media device). Hence, such technologies could readily part of smartphones, tablets, security systems, PCs, gaming technologies, virtual reality, simulation training, etc.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

It is also important to note that the functions related to processing audio signals, illustrate only some of the possible signal processing functions that may be executed by, or within, systems illustrated in the FIGURES. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto. Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes Examples and Implementations

Note that all optional features of the apparatus described above may also be implemented with respect to the method or process described herein and specifics in the examples may be used anywhere in one or more embodiments.

In a first example, a system is provided (that can include any suitable circuitry, dividers, capacitors, resistors, inductors, ADCs, DFFs, logic gates, software, hardware, links, etc.) that can be part of any type of computer, which can further include a circuit board coupled to a plurality of electronic components. The system can include means for clocking data from the digital core onto a first data output of a macro using a first clock, the first clock being a macro clock; means for clocking the data from the first data output of the macro into the physical interface using a second clock, the second clock being a physical interface clock; means for clocking a first reset signal from the digital core onto a reset output of the macro using the macro clock, the first reset signal output used as a second reset signal; means for sampling the second reset signal using a third clock, which provides a clock rate greater than the rate of the second clock, to generate a sampled reset signal; and means for resetting the second clock to a predetermined state in the physical interface in response to a transition of the sampled reset signal,

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

It is to be understood that the foregoing description is intended to illustrate and not to limit the scope of the invention, which is defined by the scope of the appended claims. Other embodiments are within the scope of the following claims.

1. A method for filtering noise from an input signal in a computationally efficient manner, comprising:
generating a raw noisy matrix representing the input signal, wherein each element of the raw noisy matrix represents a portion of the input signal;
initializing a denoised matrix as equal to the raw noisy matrix;
updating the denoised matrix by iteratively:
convolving a current version of the denoised matrix with a kernel to generate a convolution matrix,
modifying the denoised matrix based in part on values in the convolution matrix.

2. The method of claim 1, further comprising generating a confidence-weighted noisy matrix, based on a confidence level of elements of the raw noisy matrix.

3. The method of claim 2, wherein updating the denoised matrix further comprises adding the convolution matrix and the confidence-weighted noisy matrix to produce a probabilistic strength matrix.

4. The method of claim 3, wherein updating further comprises generating a matrix of probabilities based on the probabilistic strength matrix by applying a nonlinearity function to elements of the probabilistic strength matrix to generate a matrix of probabilities, and
wherein the denoised matrix is modified based on a subset of elements in the matrix of probabilities.

5. (canceled)

6. The method of claim 3, wherein updating the denoised matrix further comprises:
selecting the subset of elements in the probabilistic strength matrix, and
replacing values of corresponding elements in the denoised matrix with new values based on probabilities in corresponding elements in the matrix of probabilities.

7. The method of claim 6, wherein the subset is selected at random.

8. The method of claim 1, further comprising:
generating a weighting matrix, wherein the weighting matrix is the same size as the raw noisy matrix, and wherein each element of the weighting matrix represents a confidence level of a corresponding element of the raw noisy matrix; and
generating a confidence-weighted noisy matrix based on the raw noisy matrix and the weighting matrix.

9. The method of claim 8, wherein combining comprises multiplying element-wise the weighting matrix by the raw noisy matrix.

10. (canceled)

11. The method of claim 1, further comprising:
averaging a plurality of denoised matrices each generated at an updating iteration, and
outputting an average of the plurality of denoised matrices.

12. The method of claim 1, wherein the input signal is an audio signal and the raw noisy matrix elements each have a value based on information at a selected analysis frame and frequency.

13. The method of claim 1, further comprising processing the input signal using a fast Fourier transform, and wherein the convolution of the current version of the denoised matrix and the kernel is in the frequency domain.

14. The method of claim 1, wherein generating a raw noisy matrix, initializing a denoised matrix, and updating the denoised matrix includes at least one of:
generating a plurality of raw noisy matrices in parallel, each of the plurality of raw noisy matrices representing a portion of the input signal,
initializing a plurality of denoised matrices in parallel, and
updating the plurality of denoised matrices in parallel,
wherein each of the plurality of denoised matrices corresponds to one of the plurality of raw noisy matrices.

15. The method of claim 1, wherein the input signal is an audio signal and the raw noisy matrix elements are time-frequency bins.

16. A system for filtering noise from an input signal in a computationally efficient manner, comprising:
a receiver for receiving the input signal;
a computer-implemented processing module configured to:
generate a raw noisy matrix representing the input signal, wherein each element of the raw noisy matrix represents a portion of the input signal;
initialize a denoised matrix as equal to the raw noisy matrix;
update the denoised matrix by iteratively:
convolving a current version of the denoised matrix with a kernel to generate a convolution matrix,
modifying the denoised matrix based in part on values in the convolution matrix.

17. The system of claim 16, wherein the computer-implemented processing module comprises a plurality of parallel computer-implemented processing modules, each configured to:
generate a parallel raw noisy matrix, wherein each of the plurality of parallel raw noisy matrices represents a portion of the input signal, and
initialize and update a parallel denoised matrix, wherein each of the plurality of parallel denoised matrices corresponds to one of the plurality of parallel raw noisy matrices.

18. The system of claim 17, wherein each of the plurality of parallel computer-implemented processing modules updates a single element of a respective parallel denoised matrix.

19. The system of claim 16, wherein the computer-implemented processing module comprises a plurality of parallel computer-implemented processing modules, each configured to:
select, in parallel, an element of the denoised matrix, and
update, in parallel, the respective element of the denoised matrix,
wherein each of the parallel computer-implemented processing modules selects a different element.

20. (canceled)

21. A method for filtering noise from an input signal in a computationally efficient manner, comprising:
receiving the input signal;
generating a raw matrix representing the input signal, wherein each element of the matrix represents a portion of the input signal;
forming a smoothed matrix by copying the raw matrix;
updating the smoothed matrix by iteratively:
convolving the smoothed matrix and a kernel to generate a convolution matrix, and
modifying the smoothed matrix based on components of the convolution matrix.

22. The method of claim 21, wherein the input signal is an audio signal and the raw matrix elements each have a value based on relative phase information at a selected analysis frame and frequency.

23. The method of claim 22, further comprising processing the input signal using a fast Fourier transform, and wherein the convolution of the smoothed matrix and the kernel is in the frequency domain.

24. The method of claim 21, wherein the input signal includes a target signal and a noise signal, and further comprising separating the target signal from the noise signal using the smoothed matrix.

25. The method of claim 24, wherein using the smoothed matrix to separate the target signal from the noise signal includes:
combining the smoothed matrix values and the raw matrix values to determine components of the target signal, and
combining the components of the target signal to generate a filtered target signal.

26. The method of claim 21, wherein:
generating a raw matrix includes generating a plurality of raw matrices in parallel, each of the plurality of raw matrices representing a portion of the input signal, and
forming and updating the smoothed matrix includes forming and updating a plurality of smoothed matrices in parallel, each of the plurality of smoothed matrices corresponding to one of the plurality of raw matrices.

27. The method of claim 21, wherein updating the smoothed matrix includes selecting a subset of convolution matrix components, and wherein modifying the smoothed matrix includes modifying the smoothed matrix at locations corresponding to the selected convolution matrix components.

28. (canceled)

29. The method of claim 21, wherein the noise is salt-and-pepper noise.

30-36. (canceled)
